(19) United States
(12) Patent Application Publication
(10) Pub. No.: US 2005/0177370 A1
(43) Pub. Date: Aug. 11, 2005

(54) Voice recorder with sound reminder

(76) Inventors: Shih-Ming Hwang, Irvine, CA (US); Chien-Jong Hwang, Irvine, CA (US); Liang-Lun Hwang, Irvine, CA (US)

Correspondence Address: APEX JURIS, PLLC, 13194 EDGEWATER LANE NORTHEAST, SEATTLE, WA, 98125, US

(21) Appl. No.: 10/772,696

(22) Filed: Feb. 5, 2004

(51) Int. Cl. G04B 47/00

(52) U.S. Cl. 704/270

(57) ABSTRACT

A voice recorder with sound reminder, the voice recorder comprises a central processing unit, a switch module, a memory module, a voice recording module, a speaker module and a display module; the user presses the setting button for setting the switch module, and the outer data of acoustic wave is transmitted to the central processing unit by the voice recording module, and the user programs time of the timer through the number that the user presses the setting button to record the voice in certain sections. The central processing unit saves a plurality of voice data and writes the data into the memory module; the signal is transmitted to the central processing unit while the time is on the predetermined schedule. The central processing unit reads the voice recorded data in the memory module according to the received signal, and plays the voice that was preliminarily recorded. The central processing unit can also automatically play the recorded voice data according to the set schedule by the setting mode of the switch module.

### BACKGROUND OF THE INVENTION

1. Field of the Invention

The invention relates to a voice recorder with sound reminder, and more particularly to a voice recorder with sound reminder having a timer that provides a plurality of time sections, such as 1, 3, 10, 20 or 30 minutes; the user can preliminarily record acoustic wave data of the voice with various time sections according to respective requirement, and the preliminary recorded data can be arranged in the calendar as a predetermined schedule for sound reminding.

2. Description of the Prior Art

The main feature of the digital voice recorder is to use the non-vaporized memory and recording and managing voice signal in a digital manner to replace the function and access of analog tapes, thus the application of the voice recorder becomes more and more convenient. The voice recorder product will be improved gradually with technology that changes with each passing day, and the function thereof becomes various. The conventional voice recorder product has the following disadvantages:
1. The voice data saved therein are regular and monotone and fail to provide the user with multi-selection and function for recording voice data with the mark as requirement.
2. The conventional voice recorder only provides a single function for recording and playing, and the function is unchanged and insufficient.

Therefore, it is advantageous to provide the function for changing the voice data depend on the requirement and calendar of the user; thus, the user can change the contents of the voice according to the requirement of the event.

The inventor has noticed the various disadvantages associated with the above-described voice recorder and thought to improve it, and after having carried out an intensive study for many years, has successfully developed a voice recorder with sound reminder.

### SUMMARY OF THE INVENTION

The object of the present invention provides a voice recorder with sound reminder having a plurality of sections for timing, playing and recording.

The second object of the present invention provides a timer for providing multi-alert or auto work with timer; and a voice recorder with sound reminder that provides the function such as twinkling light, the alert from the speaker, running text reminding display, auto play, and auto record. The another object of the present invention provides a voice recorder with sound reminder that is capable of programming the time of the timer, such as 1, 3, 10, 20, and 30 minutes.

Another object of the present invention provides a method for implementing in a portable voice recorder or voice recordable/play product for reminding the user to record/play the voice or implement other work.

The voice recorder with sound reminder for achieving the objects of the present invention as described above mainly comprises: a central processing unit, a switch module, a voice recording module, a speaker module, a display module and a memory module; wherein the voice recording module records voiceprint data out of the voice recorder and transmitting the data to the central processing unit for managing and controlling the data. The central processing unit reads the schedule and event preliminarily set in the switch module and manages and moves the action of peripheral modules and signal data for managing and controlling a whole calendar of the voice recorder; the central processing unit displays a part of the schedule or event of the whole calendar of the voice recorder by a display module, and plays a voiceprint data pointed by the central processing unit through a speaker module

### BRIEF DESCRIPTION OF THE DRAWINGS

The drawings disclose an illustrative embodiment of the present invention which serves to exemplify the various advantages and objects hereof, and as follows:

FIG. 1 is a block diagram that shows a voice recorder with sound reminder of the present invention;

FIG. 2 is a first flow chart of the operation flow of the present invention;

FIG. 3 is a second flow chart of the operation flow of the present invention;

FIG. 4 is a third flow chart of the operation flow of the present invention;

FIG. 5 is a flow chart that shows the play of multi-notice signals.

### DETAILED DESCRIPTION OF THE PREFERRED EMBODIMENT

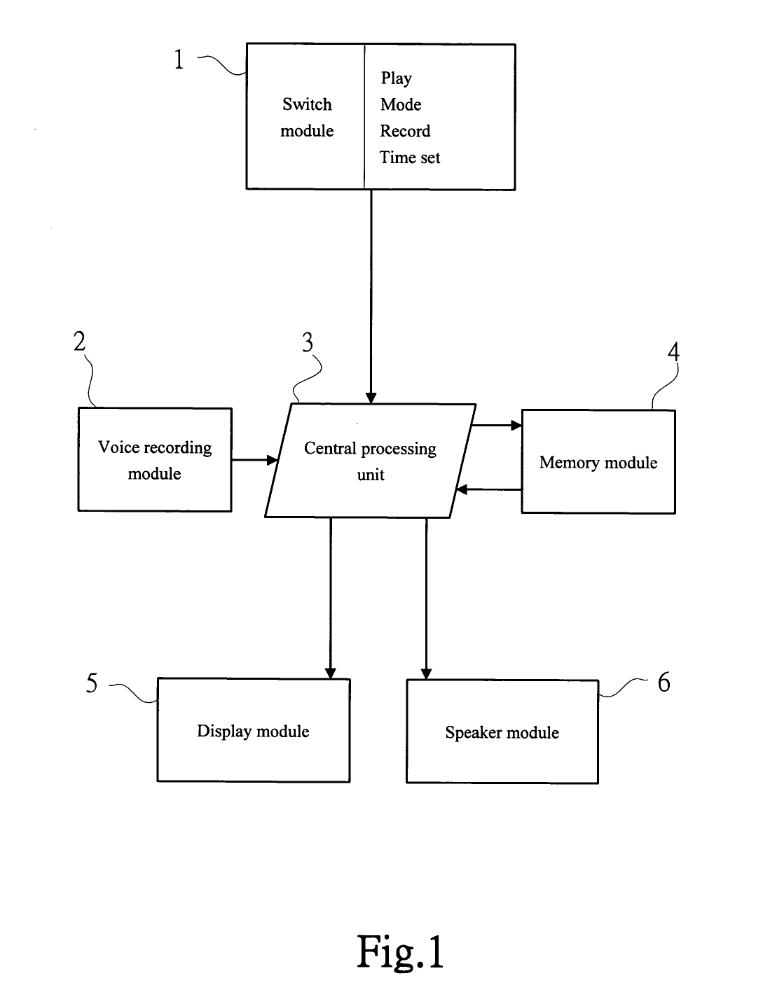

Please referring to FIG. 1, it is a block diagram that shows the voice recorder with sound reminder, the voice recorder with sound reminder mainly comprises: a central processing unit 3, a switch module 1, a voice recording module 2, a speaker module 6, a display module 5 and memory module 4.

The central processing unit 3 is a CPU. The central processing unit 3 manages and controls a whole calendar of the voice recorder, and manages and moves the action of peripheral modules and signal data by reading the schedule and event preliminarily set in the switch module; or displays a part of the schedule or event of the whole calendar of the voice recorder by a display module 5, or plays a voiceprint data pointed by the central processing unit 3 through the speaker module 6.

The switch module 1, the output of the switch module 1 connects to the central processing unit 3, and the switch module 1 comprises a Read Only Memory (ROM) having a software program preliminary burned therein, and the central processing unit 3 implements the function of recording, playing, alert or sound reminding by the software program.

A voice recording module 2 mainly comprises a microphone and a signal circuit. The voice recording module 2 collects and transfers the voiceprint data to a digital signal and inputs the digital signal to the central processing unit 3.

The speaker module 6 mainly comprises a speaker and a vibrator. The speaker controlled by the central processing unit 3 for transferring the digital signal input from the central processing unit 3 to an acoustic wave and broadcasting outward. The vibrator receives the signal and broadcast a fixed frequency vibration alert.

The memory module 4 mainly comprises an Electrically Erasable & Programmable ROM (EEPROM), and the memory module 4 changes the data thereof only when the central processing unit 3 provides a voltage thereon, and the memory module 4 is controlled by the central processing unit 3 for saving the data therein or reading the data by the central processing unit 3.

The user presses the setting button in the switch module for contenting the respective recording/playing requirement. The voice recording module 2 collects voiceprint data that are required by the user and transfers the voiceprint data to a digital signal and inputs the digital signal to the central processing unit 3. The central processing unit 3 saves the recorded digital signal in the memory module 4 according to the sections, or reads the signal from the memory module 4 according to the setting of the switch module 1, and transmits the signal to the speaker and vibrator module 6 for transferring the digital signal to an acoustic wave and broadcasting outward. The voice recorder can also connects to a personal computer for transmitting data via USB transmission port or IR transmission port.

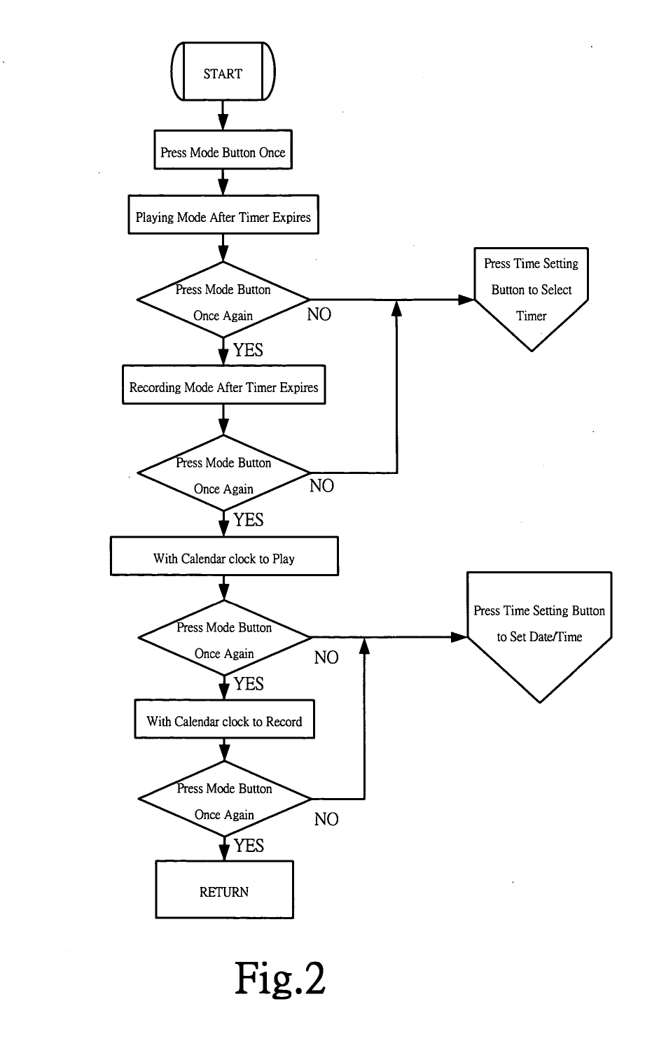

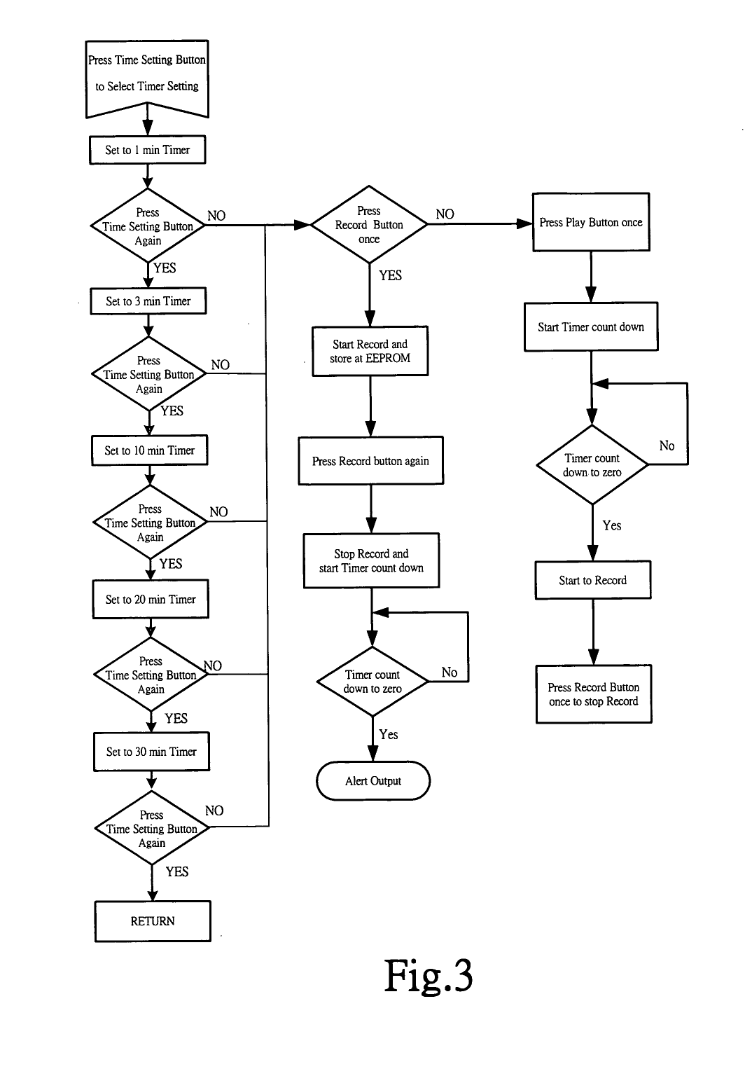

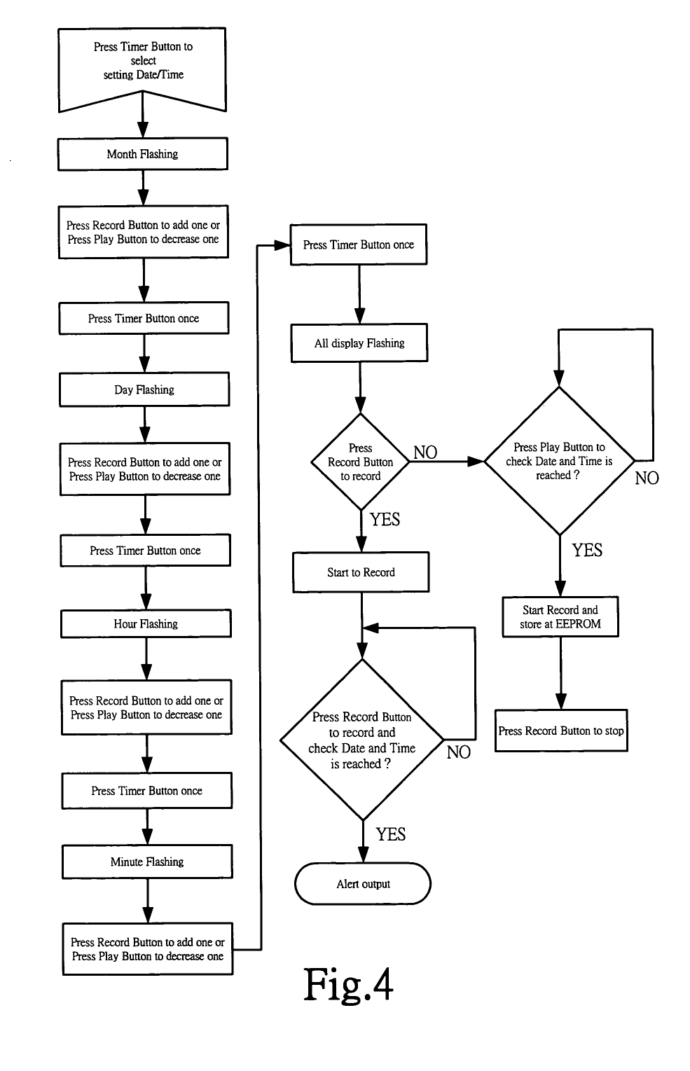

Please referring to FIG. 2, it shows the first flow chart of the voice recorder with sound reminder of the present invention. The flow shows the processing state that the process of the central processing unit when the user presses the mode button for contenting the respective recording/playing requirement. When the power is turned on, the present invention will be held on a start state, and the user can press mode switch for setting different modes and turns the mode to a playing mode after timer expires. The user determines whether to press the mode button or not, if yes, the mode was changed to the next mode that is a recording mode after timer expires; if the mode button is not pressed, the user can press the time setting button of timer for selecting the setting of the timer (such step will be continuously illustrated in FIG. 3). The user can press button for switching the mode into a playing mode with calendar clock. If the user does not keep on pressing the mode button, he can press the time setting button of timer for selecting the setting of date/time (such step will be continuously illustrated in FIG. 3). If the user continuously presses the mode button, the mode will be switching into a recording mode with calendar clock. If the user does not keep on pressing the mode button, he can press the time setting button of timer for selecting the setting of date/time (such step will be continuously illustrated in FIG. 4). If the user press the mode button again, the mode will be back to the initial state.

Please referring to FIG. 3, it shows the second flow chart of the voice recorder with sound reminder of the present invention. The flow is a follow-up of the above description. When the timer is set in a playing mode with timer or a recording mode with timer. When the user press the time setting button to set the timer, the present can program the time of the timer by a number that the user presses the time setting button, and provides five time periods of the timer, such as 1, 3, 10, 20 and 30 minutes, to be rapidly selected by the user. Each time the user presses the time setting button, the length of time in the timer will be increased a standard. When the user finishes time setting, he can press the recording button to starting recording and saving the data into EEPROM; next, the user press the recording button again, and the timer begins to count down, as the timer counts to zero, the output module outputs a voice reminding, sound, light or vibration signal to be notice data. Instead of pressing the recording button, the user presses the playing button for initializing a count down of the timer. As the timer counts to zero, the voice recorder begins to record. If the user wants to stop recording, he can just press the recording button again.

Please referring to FIG. 4, it shows the third flow chart of the voice recorder with sound reminder of the present invention. The flow is a follow-up of the above description. The user can press the time setting button for setting date/time. The present invention mainly utilizes running text for displaying the notification. When the user press the time setting button for setting time, the LCD screen of the display module can sequentially show the numeral display of the running month, data, hour, and minute. The user can press the recording/playing switch for increasing/decreasing the numeral display and press the time setting button for confirming the setting. After the predetermined time setting is finished, all the set selection can be show on the LCD screen. If the user presses the recording button, the recorder begins to record and the user can press the recording button again to stop recording. Then, the recorder starts checking if the time reaches the set date/time. If the time does not reach the set clock, the timer continuously counts the time; if the time reach the set clock, the output module outputs a voice reminding, sound, light or vibration signal to be notice data. The user presses the playing button to check if the time reaches the set clock. If the time does not reach the set clock, the timer continuously counts the time; if the time reach the set clock, the recorder starts recording and saving the data in EEPROM. The user can press the recording button again to stop recording.

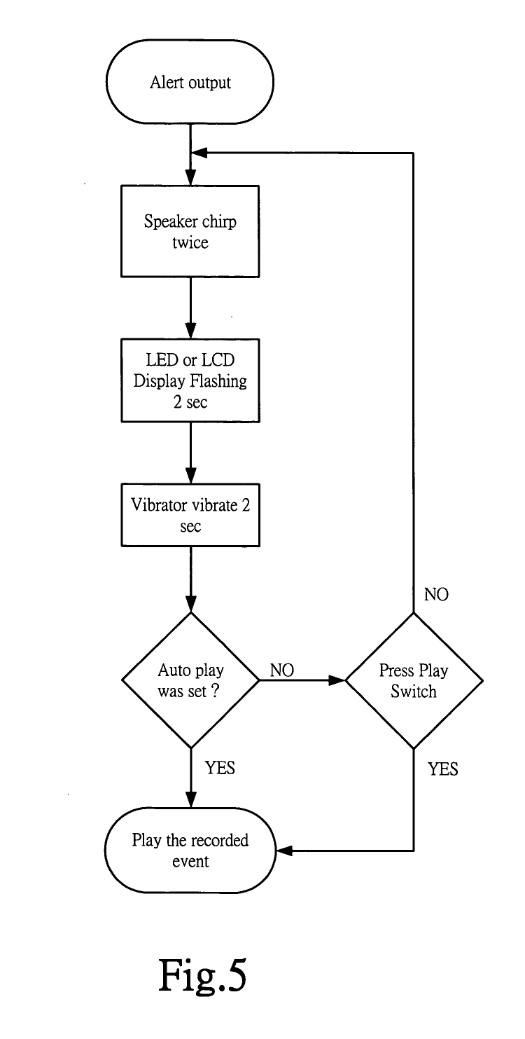

The present invention is capable of providing multi-alert or auto recording with timer setting. Please referring to FIG. 5, it is a flow chart that shows multi-alert playing sound of the present invention. When the central processing unit outputs acoustic wave data, the speaker chirps twice (the speaker broadcast an alert sounds like “Gi”, “Gi”) and the screen of LCD or LED shows the flash that lasts two seconds; if the recorder has been set in the auto playing mode, it can auto play the voice reminding event recorded preliminarily according to the setting.

The voice recorder with sound reminder provided by the present invention has the following advantages when comparing to the other conventional voice recorder:
1. The present invention provides functions for auto recording voice reminding data with calendar clock. The present invention makes the conventional digital voice recorder having playing/recording sections therein with timing clock, and the user can use the voice recorder that is capable of auto recording the required voice and playing the voice on the proper time selected by the user with the calendar event.
2. The timer of the present invention is capable of providing multi-alert or auto playing/recording with timer.
3. The present invention programs the time of the timer into various time sections via a number that the user presses the time setting button for fast setting the recorder.
4. The present invention provides multi-events time setting for conveniently arranging a calendar clock with long time and avoiding the inconvenience of keying the text and symbol with keyboard, and directly records the dictation for auto playing and reminding at the set time.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

1. A method for implementing a function of timing and sound reminding in a voice recorder, the method comprising the following steps:
(a) after initiating the voice recorder, a user pressing a mode button for setting a mode switch;
(b) the user pressing the mode button for selecting a recording, going to step (c); or playing function with timer, going to step (d);
(c) the user pressing the time setting button for setting a timer;
(d) the user pressing the time setting button for setting a time and date of a schedule;
(e) a central processing unit saving a recording data into a memory according to the setting of the switch of the menu after identification, or reading the recording data in the memory for playing of the data after receiving a notice signal.

2. The method according to claim 1, wherein the timer of step (c) being capable of programming the period of the timer by a number that the user presses the setting button.

3. The method according to claim 1, wherein the period of the timer is 1, 3, 10, 20 or 30 minutes.

4. The method according to claim 1, wherein the notice signal in step (e) being an alert sounded like “gi” “gi” generated from a beeper directed by the central processing unit.

5. The method according to claim 1, wherein the notice signal in step (e) being a vibration notice signal generated from a vibrator directed by the central processing unit.

6. The method according to claim 1, wherein the notice signal in step (e) is displayed on the screen of LCD by the central processing unit.

7. The method according to claim 1, wherein the notice signal in step (e) is a twinkling light of LED controlled by the central processing unit.

8. A voice recorder with sound reminder comprising:
a central processing unit for managing and controlling a whole calendar of the voice recorder, and for managing and moving the action of peripheral modules and signal data by reading the schedule and event preliminarily set in the switch module; or displaying a part of the schedule or event of the whole calendar of the voice recorder by a display module, or playing a voiceprint data pointed by the central processing unit through a speaker module;
a time controlling circuit comparing whether or not the planning time of the schedule being consistent with the present time;
a switch module, the output of the switch module connecting to the central processing unit, and the switch module comprising a Read Only Memory (ROM) having a software program preliminary burned therein, and the central processing unit implementing the function of recording, playing, alert or sound reminding by the software program;
a memory module, the memory module changing the data thereof only when the central processing unit providing a voltage thereon, and the memory module being controlled by the central processing unit for saving the data therein or reading the data by the central processing unit;
a voice recording module for collecting voiceprint data and transferring the voiceprint data to a digital signal and inputting the digital signal to the central processing unit;
a speaker and vibration module controlled by the central processing unit for transferring the digital signal input from the central processing unit to an acoustic wave and broadcasting outward;
a display module controlled by the central processing unit for displaying the digital signal input from the central processing unit via LCD or LED;
a recording/playing circuit being a hardware device for the central processing unit implementing the recording function and transferring the recorded voice to digitized data and saving the data in a Random Access Memory (RAM).

9. The voice recorder with sound reminder according to claim 7, wherein the speaker and vibration module is a horn.

10. The voice recorder with sound reminder according to claim 7, wherein the speaker and vibration module is a vibrator.

11. The voice recorder with sound reminder according to claim 7, wherein the voice receiving module is a microphone.

12. The voice recorder with sound reminder according to claim 7, wherein the voice recorder connects to a personal computer via a USB transmission port for transmitting data.

13. The voice recorder with sound reminder according to claim 7, wherein the voice recorder connects to a personal computer via an infrared transmission interface for transmitting data.
